(19) United States
(12) Patent Application Publication
(10) Pub. No.: US 2019/0139189 A1
(43) Pub. Date: May 9, 2019

(54) IMAGE REMOSAICING

(71) Applicant: QUALCOMM Incorporated, San Diego, CA (US)

(72) Inventors: Naveen Srinivasamurthy, Bangalore (IN); Mahant Siddaramanna, Bangalore (IN); Animesh Behera, Bangalore (IN); Pawan Kumar Baheti, Bangalore (IN)

(21) Appl. No.: 15/804,898

(22) Filed: Nov. 6, 2017

(51) Int. Cl. G06T 3/40

(52) U.S. Cl. CPC G06T 3/4015; G06T 2200/32; G06T 3/4007

(57) ABSTRACT

Image processing can include producing a first mosaic of an image with a first spectral pattern, assigning a context to the first mosaic, classifying the first mosaic based on the assigned context, and producing a second mosaic of the image based on the classifying. The second mosaic can have a second spectral pattern different than the first spectral pattern.

### CROSS-REFERENCE TO RELATED APPLICATIONS

None.

### STATEMENT ON FEDERALLY SPONSORED RESEARCH OR DEVELOPMENT

None.

### BACKGROUND

### Field of the Disclosure

The present disclosure relates to digital image processing.

### Description of Related Art

Digital cameras often include a lens and an image sensor panel with millions of camera pixels. A lens directs incoming light from a scene onto the image sensor panel. Each camera pixel can include one or more photodiodes. The photodiodes capture metrics of the incoming light. One or more processors (e.g., circuitry) produces (e.g., processes, prepares, generates, etc.) an image based on the captured metrics.

The image sensor panel often includes a spectral filter array (also called a color filter array) disposed optically upstream of the photodiodes. The incoming light passes through the spectral filter array before contacting the photodiodes. A spectral filter array typically includes three or more different kinds of spectral filters (e.g., red, green, and blue), arranged in a spectral pattern.

The spectral filter array allows the camera to capture color images. Each pixel typically includes one kind of spectral filter. The pixel's one or more photodiodes capture metrics of the light channel spectrum associated with the spectral filter. For example, a pixel with a red spectral filter will measure red channel light; a pixel with a green spectral filter will measure green channel light.

One or more processors eventually read out each pixel. Because each pixel measures one spectral channel (e.g., red), the readout results in an image mosaic where each image pixel has one spectral channel. In contrast, a typical multi-channel image (also called a full-color image) assigns a plurality of (e.g., three) spectral channels to each image pixel.

To produce a multi-channel image, multi-interpolation (also called full-color interpolation) can be performed to estimate the missing spectral channels for each image pixel. For example, if an image pixel includes a red spectral channel value, but is missing blue and green spectral channels, the processing system will assign the missing blue and green spectral channels to the image pixel through multi-interpolation.

### SUMMARY

A method of image processing can include: producing a first mosaic of an image, the first mosaic having a first spectral pattern; assigning a context to the first mosaic; classifying the first mosaic based on the assigned context; and producing a second mosaic of the image based on the classifying. The second mosaic can have a second spectral pattern different than the first spectral pattern. The method can be performed by a mobile device, such as a smartphone.

A processing system for imaging can include one or more processors configured to: produce a first mosaic of an image based on metrics captured by an image sensor, the first mosaic having a first spectral pattern; assign a plurality of contexts to the first mosaic; classify the first mosaic based on the plurality of contexts; and produce a second mosaic of the image based on the classification. The second mosaic can have a second spectral pattern, different than the second spectral pattern. The processing system can be an aspect of a mobile device, such as a smartphone.

A processing system for imaging, can include: (i) means for producing a first mosaic of an image, the first mosaic being arranged in a first spectral pattern, the first mosaic comprising a plurality of image pixels, each of the plurality of image pixels having a first spectral channel when in the first mosaic; (ii) means for (a) assigning a first context some image pixels in the first mosaic and (b) a second context to other image pixels in the first mosaic; (iii) means for classifying the first mosaic based on first and second assigned contexts; (iv) means for producing a second mosaic of the image based on the classifying.

The second mosaic can be arranged in a second spectral pattern. The second mosaic can include the plurality of image pixels. Each of the plurality of image pixels can have a second spectral channel when in the second mosaic. The second spectral pattern can be different than the first spectral pattern.

A non-transitory computer-readable storage medium can include program code. The program code, when executed by one or more processors, can cause the one or more processors to: produce a first mosaic of an image based on metrics captured by an image sensor, the first mosaic having a first spectral pattern; assign a plurality of contexts to the first mosaic; classify the first mosaic based on the plurality of contexts; and produce a second mosaic of the image based on the classification. The second mosaic can have a second spectral pattern, different than the second spectral pattern.

### BRIEF DESCRIPTION OF DRAWINGS

For clarity and ease of reading, some Figures omit views of certain features. Unless expressly stated otherwise, the Figures are not to scale and features are shown schematically.

FIG. 1 shows two example mobile devices capturing a scene.

FIG. 2 shows a back of an example mobile device.

FIG. 3 is a cross sectional view of an example camera.

FIGS. 4 and 5 are cross sectional side views of example sensor panels.

FIG. 6 is a zoomed cross sectional side view of an example sensor panel.

FIG. 6A is a cross sectional plan view of an example sensor panel, the cross section being arranged to reveal a spectral filter array.

FIG. 7 is a plan view of a portion of a Bayer spectral pattern.

FIG. 8 is a plan view of a portion of a Quadra spectral pattern.

FIG. 9 is a plan view of a portion of a Bayer with Phase Detection spectral pattern.

FIG. 10 is a plan view of a portion of a RGB with Infrared spectral pattern.

FIG. 11 is a block diagram of an example method.

FIG. 12 is a block diagram of an example method that can occur during block 1108 of FIG. 11.

FIG. 13 shows an example scene.

FIGS. 14-16 show example spectral patterns of image mosaics.

FIG. 17 is a block diagram of an example method.

FIG. 18 is a block diagram of an example processing system.

### DETAILED DESCRIPTION

While the features, methods, devices, and systems described herein can be embodied in various forms, some exemplary and non-limiting embodiments are shown in the drawings, and are described below. The features described herein are optional. Implementations can include more, different, or fewer features than the examples discussed.

At times, the present disclosure uses relative terms (e.g., front, back, top, bottom, left, right, etc.) to give the reader context. The claims are not limited to these relative terms. Any relative term can be replaced with a numbered term (e.g., left can be replaced with first, right can be replaced with second, and so on).

The subject matter is described with illustrative examples. The claimed inventions are not limited to these examples. Changes and modifications can be made to the claimed inventions without departing from their spirit. The claims embrace such changes and modifications.

Technology disclosed in the present application enables context-driven remosaicing. To capture an image, a camera can measure light coming from a scene. A processing system can convert those measurements into a full-color image. To do so, the processing system can read-out the measurements of light captured by the camera. If the camera includes a spectral filter, then the processing system can read-out a first mosaic of the image. The first mosaic can be a spectral pattern corresponding to the spectral filter.

To convert the first mosaic into the full-color image (also called a multi-channel image), the processing system can perform full-color interpolation (also called multi-channel interpolation). However, the processing system might not be capable of performing full-color interpolation on the first mosaic. As a result, the processing system may need to convert the first mosaic into a second mosaic, then run full-color interpolation on the second mosaic.

Among other things, the present application enables efficient and accurate conversion (i.e., remosaicing) of a first mosaic into the second mosaic. To do so, the processing system can remosaic based context of the first mosaic. The processing system can assign context to the first mosaic based on one or more statistical measurements of the first mosaic such as variance and/or standard deviation. A first mosaic with complex structure (e.g., many edges) can produce a high variance and/or standard deviation, resulting in a corresponding first context. Contrarily, a first mosaic with less structure (e.g., few edges) can produce a low variance and/or standard deviation, resulting in a corresponding second context.

The processing system can dedicate resources to the remosaicing based on the context assigned to the first mosaic. When the first mosaic has complex structure (e.g., is assigned the first context), the processing system can devote a greater amount of processing resources to remosaicing the first mosaic into the second mosaic. When the first mosaic has less structure (e.g., is assigned the second context), the processing system can devote a lesser amount of processing resourcing to the remosaicing.

The present application is not limited to the above-described technology. Other features are described below.

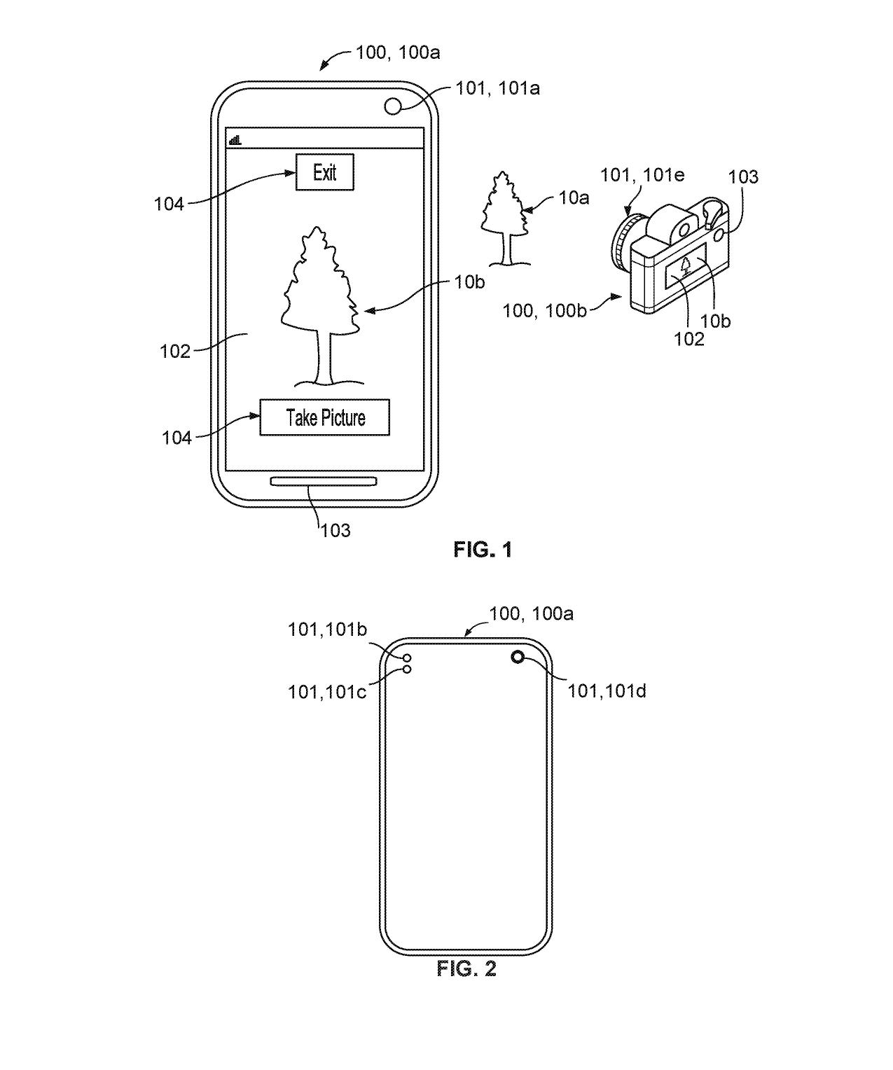

FIG. 1 shows mobile devices 100 capturing a scene 10a. Mobile device 100 can be a smartphone 100a or a camera assembly 100b. FIG. 2 shows a back of smartphone 100a. Mobile device 100 can include one or more cameras 101. Smartphone 100a can include cameras 101a-101d. Camera assembly 100b can include camera 101e. Besides cameras 101, mobile device 100 can include a frame (not labeled), a display 102, and hard buttons 103. Mobile device 100 can be configured to present soft or virtual buttons 104 on display 102.

Mobile device 100 can be configured to enter a viewfinder mode 10b where images captured by one or more cameras 101 are presented on display 102. When the user presses a hard or soft button 103, 104, mobile device 100 can be configured to preserve a stable image in memory (e.g., as a single image, as a frame of a video). Stable images are further discussed below. In general, stable images can be saved in non-volatile memory. Images can be also be transient. Transient images can be in-transit between different electronic components.

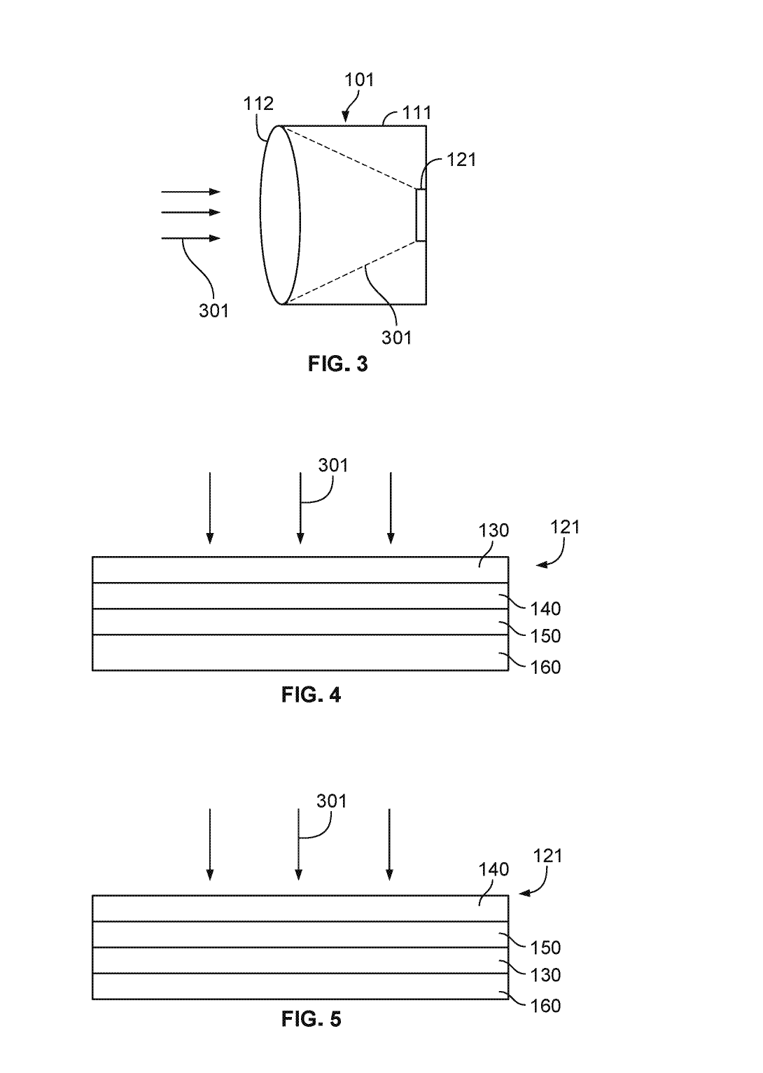

FIG. 3 is a schematic view of camera 101, which can be mounted in mobile device 100, or any other kind of system (e.g., a vehicle). Camera 101 can include a housing 111 retaining a lens 112 and a sensor panel 121. As shown in FIG. 3, lens 112 can admit light 301 from a scene (e.g., scene 10a of FIG. 1), and output converged light 301, which contacts sensor panel 121. Although not shown, camera 101 can include a plurality of lenses and other optical-mechanical elements such as apertures, shutters, mirrors, and the like.

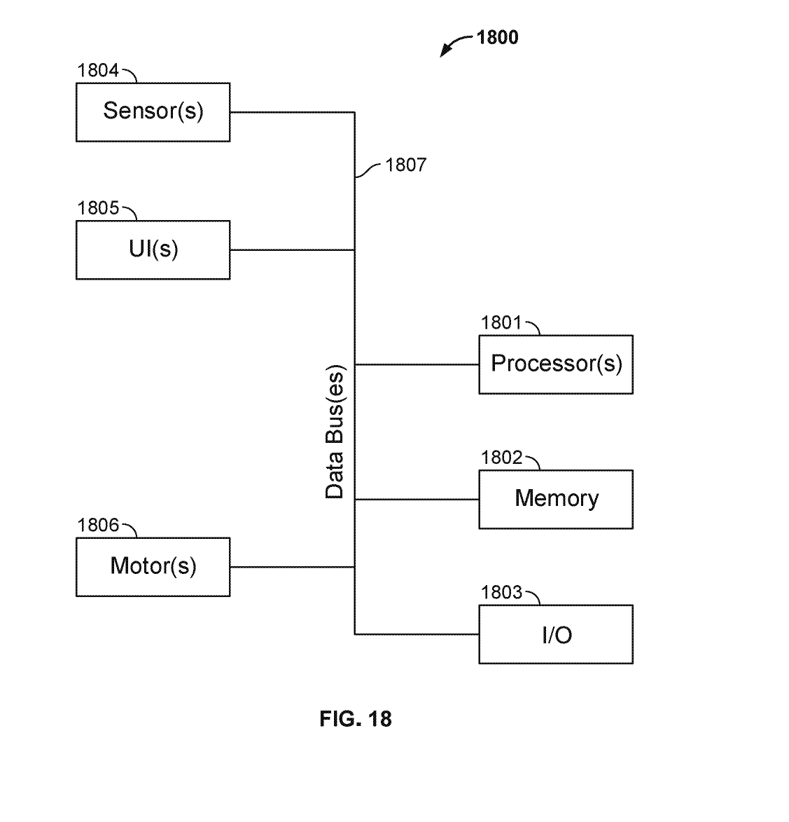

As explained below with reference to FIG. 18, mobile device 100 can include a processing system 1800 with one or more processors 1801 and memory 1802. According to some examples, camera(s) 101, display 102, and hard buttons 103, are components of processing system 1800. Processing system 1800 can be configured to perform some or all of the functions, operations, and methods disclosed herein.

Referring to FIGS. 4 and 5, sensor panel 121 (also called an image sensor and/or a pixel array) can include a microlens array 130, a spectral filter array 140 (also called a “color filter array” or a “filter array”), a spacer layer 150, and a silicon layer 160. FIGS. 4 and 5 show two possible relative arrangements of layers 130-160. According to some examples, one or both of the microlens array 130 and the spacer layer 150 can be absent. According to some examples, microlens array 130 is not connected to silicon layer 160.

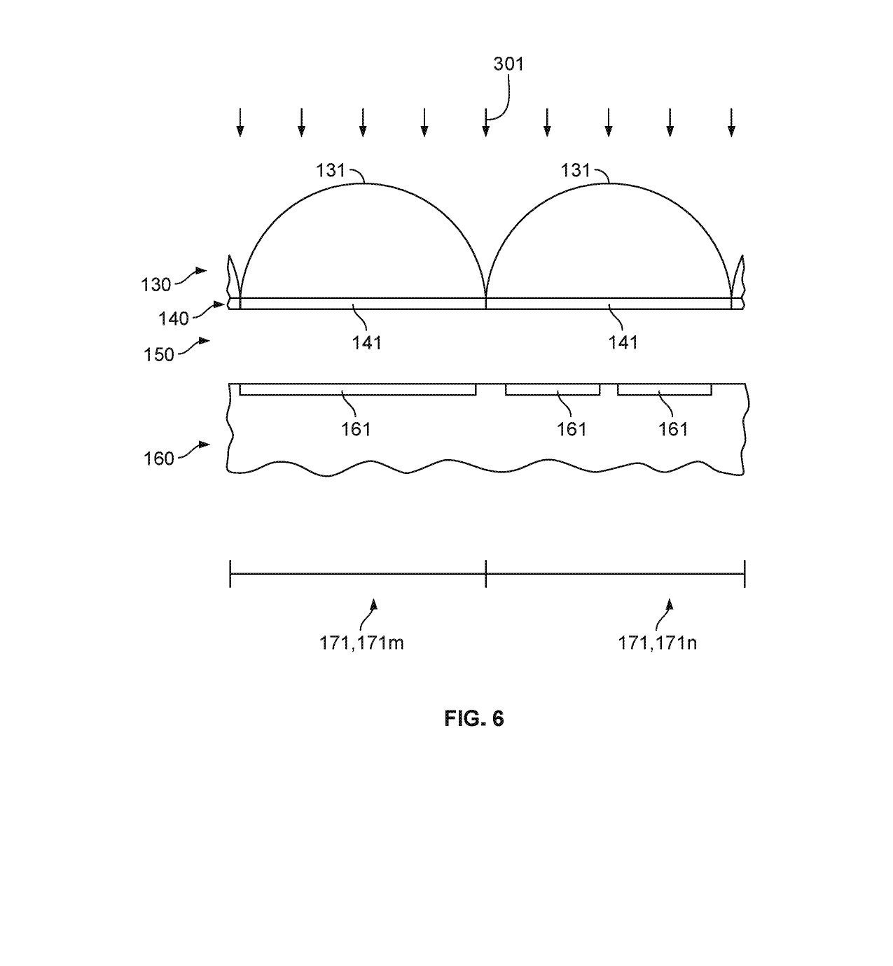

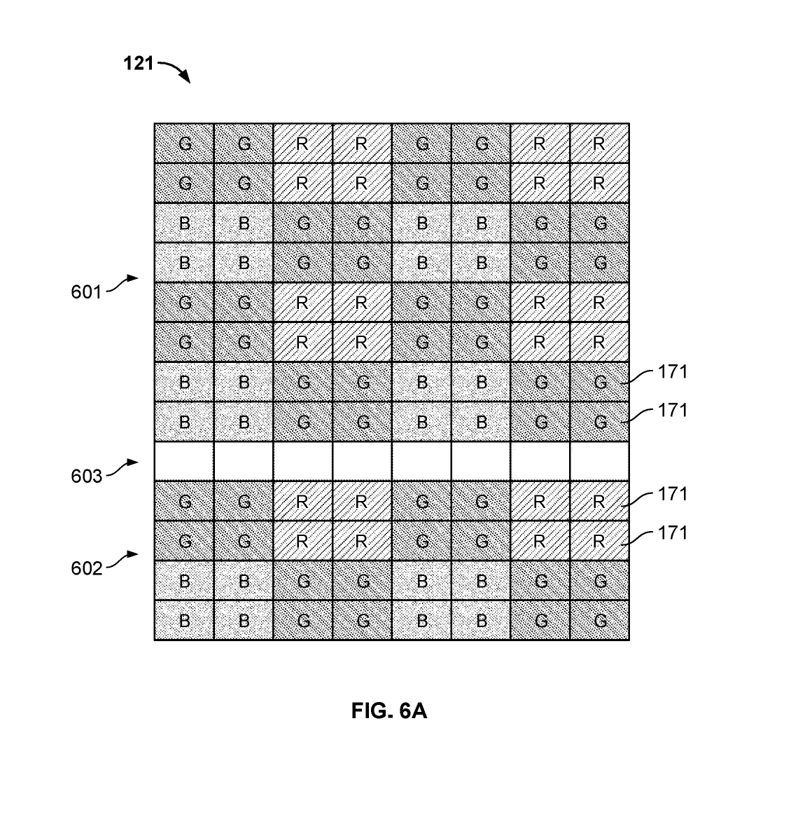

FIG. 6 is a zoomed cross sectional schematic of FIG. 4's sensor panel 121. Microlens array 130 can include a plurality of domed microlenses 131. Spectral filter array 140 can include a plurality of spectral filters 141 (also called “color filters” or “filters”). Spacer layer 150 can be a void (i.e., absence of material) a transparent hardened resin, and the like. Spacer layer 150 can support spectral filter array 140. A plurality of photodiodes 161 can be formed into silicon layer 160.

FIG. 6 shows camera pixels 171 including first camera pixel 171m and second camera pixel 171n. Each camera pixel 171 can include a microlens 131, a filter 141, a portion of spacer layer 150, and one or more photodiodes 161. First camera pixel 171m can include one photodiode 161. Second camera pixel 171n can include a plurality of photodiodes 161.

Sensor panel 121 can include a plurality of camera pixels 171 (e.g., millions of camera pixels). All camera pixels 171 can include the same number of photodiodes 161 (e.g., one, two, four, eight). Alternatively, camera pixels 171 can include varying numbers of photodiodes. For example, some camera pixels 171 can include two or four photodiodes 161 while other camera pixels 171 include a single photodiode 161. According to some examples, all camera pixels 171 include at least one photodiode 161.

As shown in FIG. 6A, camera pixels 171 can be spaced apart via an avenue 603. An avenue 603 can be a row or column across sensor panel 121. Therefore, filter array 140 can be separated into discrete portions (e.g., first portion 601 and second portion 602). Although not shown, multiple avenues 603 can exist. Some avenues can extend in non-horizontal directions (e.g., vertically). In FIG. 6A, filter array 140 has a Quadra spectral pattern, which is discussed with reference to FIG. 8 below.

Avenues 603 can lack pixels or include special pixels such as pixels with no spectral filters or pixels with black spectral filters. Processing system 1800 can fill in appropriate channels and channel values (further explained below) for first mosaic image pixels spatially mapping to avenues 603 before remosaicing the first mosaic into the second mosaic. Alternatively, processing system 1800 can leave image pixels spatially mapping to avenues 603 blank in the first mosaic and remosaic without considering these image pixels. These image pixels (i.e., the image pixels spatially mapping to avenues 603) can be filled in during multi-channel interpolation.

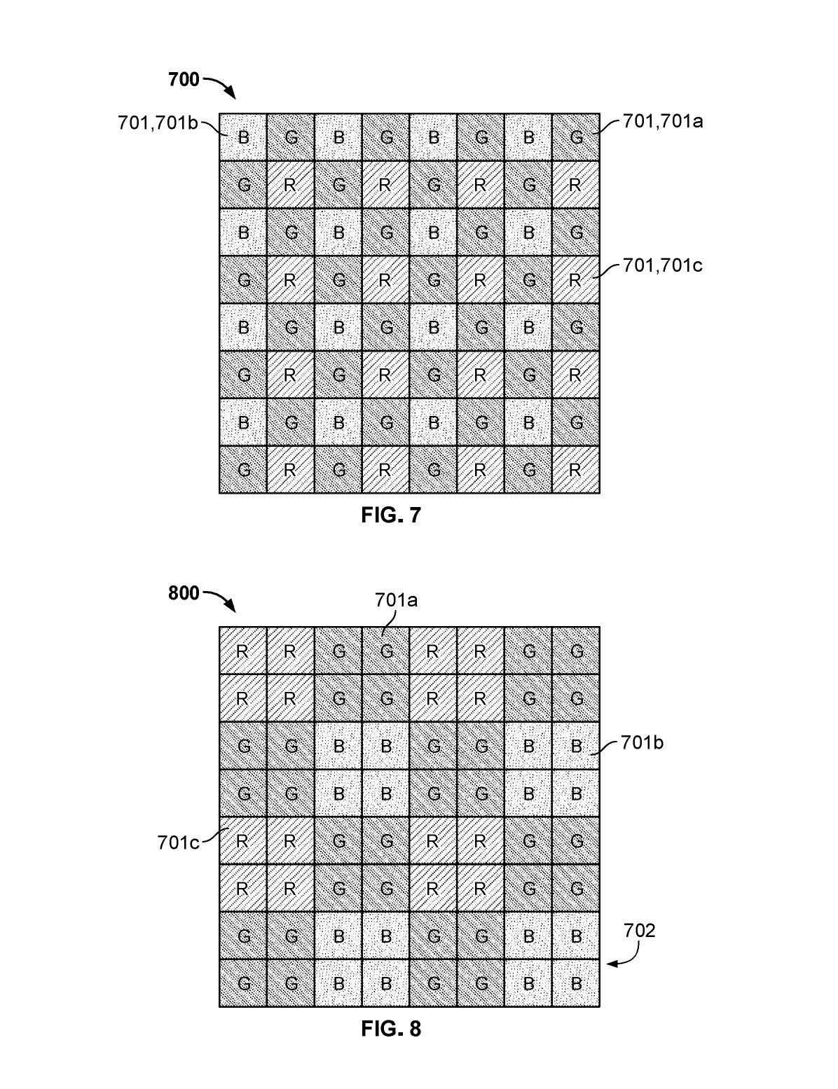

FIGS. 7-10 show example spectral patterns, including a Bayer spectral pattern 700, a Quadra spectral pattern 800, a Bayer with Phase Detection (Bayer with PD) spectral pattern 900, and a RGB with Infrared (RGB with IR array) spectral pattern 1000. As further discussed below, patterns 700-1000 can match the spectral pattern of filter array 140 or the spectral pattern of an image mosaic.

Each spectral pattern 700, 800, 900, 1000 has spectral units 701. As explained below, a spectral unit can represent a spectral filter or a spectral channel of an image pixel. Spectral units 701 can include green spectral units 701a, blue spectral units 701b, red spectral units 701c, phase detection spectral units 701d, and infrared spectral units 701e. Phase detection spectral units 701d can be any of spectral units 701a-701c, 701e. Put differently, phase detection units 701d can be green, blue, red, infrared, etc. Adjacent phase detection units 701d can have the same spectral unit (e.g., both blue, both green, etc.).

Bayer spectral pattern 700 is characterized by repeating group of four spectral units 701: two diagonal green units 701a, one blue 701b, and one red 701c.

Quadra spectral pattern 800 is characterized by a repeating group of sixteen spectral units 701: eight green units 701a arranged in two diagonal clusters of four, four blue units 701b arranged in a single cluster, and four red units 701c arranged in a single cluster.

Bayer with PD spectral pattern 900 is the Bayer spectral pattern with some spectral units substituted for one or more clusters of phase detection units 701d. Each cluster of phase detection units 701d can be a common spectrum (e.g., green 701a, blue 701b, red 701c, infrared 701d).

RGB with IR spectral pattern 1000 is similar to the Bayer spectral pattern 700, except each repeating group alternatingly replaces one red or one blue unit with an infrared unit 701e. As discussed with reference to FIG. 6A, any of patterns 700-1000 can include one or more avenues 603. Other examples of RGB with IR can be used.

Each spectral unit 701 can represent a filter 141 of filter array 140. Green filters 141 admit light within the green spectrum and block light falling outside the green spectrum. Blue filters 141 admit light within the blue spectrum and block light falling outside the blue spectrum. Red filters 141 admit light within the red spectrum and block light falling outside the red spectrum.

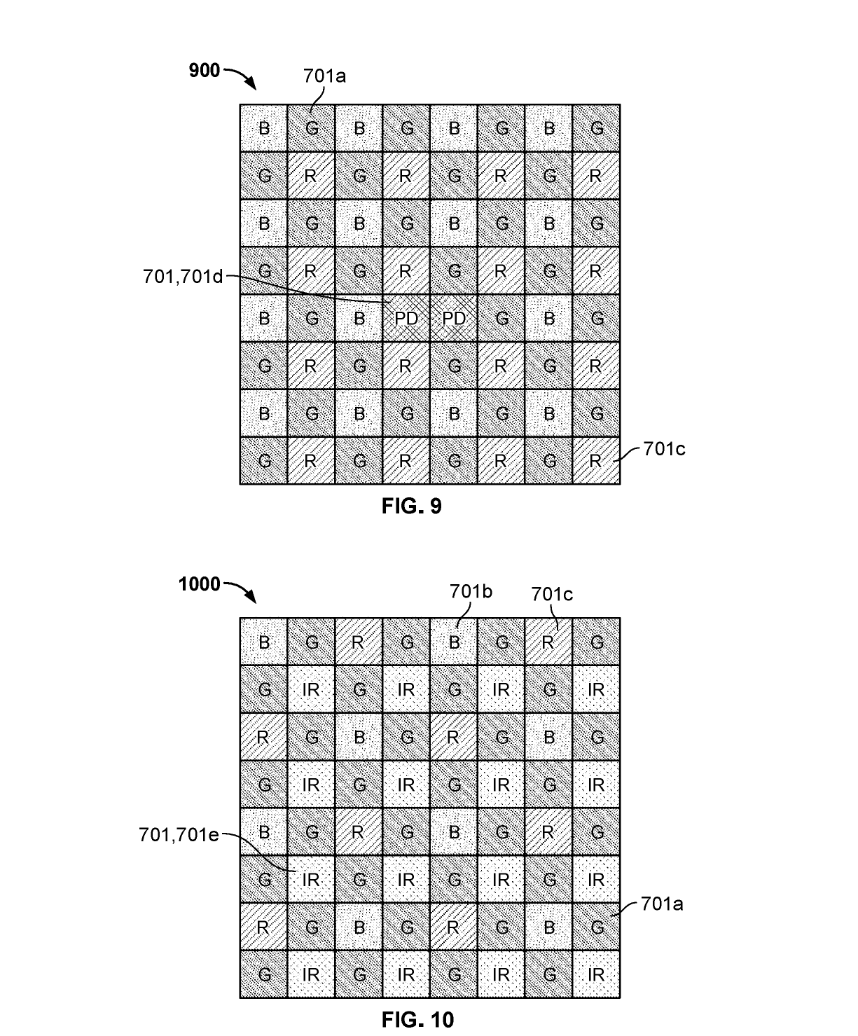

Phase detection filters 141 can be any kind of filter (e.g., green, blue, red, infrared). Each cluster of phase detection filters 141 (FIG. 9 shows a cluster of two) can be identical (e.g., all green, all blue, all red, or all infrared). Infrared filters 141 can admit light within the infrared spectrum and block light falling outside the infrared spectrum. Each filter 141 can be broken into a plurality of discrete pieces or can have a unitary and integral structure.

Each camera pixel 171 can include a filter 141 configured to admit a single spectral channel. For example, if camera 101 includes a Quadra filter array 140, then the four camera pixels with filters 141 corresponding to blue spectral unit cluster 702 would capture blue channel light, but not green or red channel light.

Filters 141 enable (e.g., allow, permit) processing system 1800 to produce a color image. Photodiodes 161 are typically incapable of distinguishing between different channels of light. Instead, photodiodes 161 typically capture the intensity of light over an integration window (also called exposure window) of camera 101. Filters 141 can cause the photodiodes of each pixel to capture a single spectral channel (e.g., red, blue, or green).

Processing system 1800 can apply this information to build (e.g., generate, produce, prepare) a multi-channel color image, where each pixel has a plurality of spectral channels (e.g., red, blue, and green). Processing system 1800 can do so via multi-channel interpolation where the missing spectral channels of each pixel are estimated (e.g., interpolated) based on known spectral channels of neighboring pixels.

Spectral patterns 700, 800, 900, 1000 can represent a spectral pattern of an image mosaic. An image mosaic can be the predecessor to a multi-channel image. Each spectral unit 701a-701e can represent a spectral channel (also called “channel”) of an image pixel.

Image pixels, which exist as digital information, are therefore different than camera pixels 171, which are hardware. Processing system 1800 can use camera pixels 171 to generate image pixels. According to some examples, processing system 1800 can produce the first mosaic by reading out camera pixels 171.

Each channel can have a spectral channel value (also called “channel value”), which quantifies a magnitude of the channel. When the present disclosure refers to an image pixel having a channel, the image pixel also includes a corresponding channel value.

Each channel value can fall in a predetermined range such as 0-255 (8-bits per channel), 0-511 (9-bits per channel), 0-1023 (10-bits per channel), 0-2047 (11-bits per channel), and so on. A channel value of 0 can indicate the absence of light within the channel. Nevertheless, when the present disclosure refers to an image pixel having a channel (e.g., green), the channel value of the pixel can be zero.

Examples of mobile device 100 are configured to produce (e.g., prepare, build, process) an image based on metrics read out from the camera pixels 171 of sensor panel 121. The image can exist in a plurality of different states. For example, the image can exist as a first mosaic, a second mosaic, and a multi-channel image.

Some of these states can be transient, where the image exists as signals in processing system 1800. Some of these states can be stable, where the image is stored in memory. A multi-channel image, for example, can have both a transient form (e.g., when being transmitted across processing system 1800) and a stable form (when preserved in memory of processing system 1800).

Whether in transient form or stable form, an image can have a resolution, which quantifies the detail that the image holds. The smallest unit of resolution can be an image pixel. An image pixel can have a color. Channel values of the image pixel can determine the color. When an image exists as a mosaic, each image pixel can have a single channel and thus a single channel value.

When an image exists as a multi-channel image, each image pixel can have multiple channels corresponding to a desired color space (e.g., three spectral channels for RGB color space; three spectral channels for CIE color space; four spectral channels for CMYK color space, etc.). Some multi-channel images can have image pixels that store the channels in a compressed form. For example, a JPEG is multi-channel image with three channel image pixels. The three channels of each image pixel are stored in a compressed format. Upon accessing a JPEG, processing system 1800 can use a codec to unpack the three channels of each image pixel.

Camera pixels 171 can 1:1 map to image pixels. For example, a camera pixel having coordinates (i, j) can be used to create an image pixel having coordinates (x, y), a camera pixel having coordinates (i+1, j) can map to an image pixel having coordinates (x+1, y), and so on. Therefore, and referring to FIGS. 7-10, a Bayer filter array 140 results in a Bayer first mosaic, a Quadra filter array 140 results in a Quadra first mosaic, and so on. As discussed below, the first mosaic can be remosaiced into a second mosaic. Therefore, an image can exist in a plurality of different states such as a first mosaic, a second mosaic, and a multi-channel (also called full-color) state.

When the present disclosure discusses an image, the image can be a two-dimensional patch of a larger image. For example, the image can represent 500 image pixels disposed in a central patch of a complete image including 4,000,000 image pixels. Alternatively, the image can represent an entire and complete image.

To convert an image from a mosaic into a multi-channel image, processing system 1800 can perform multi-channel interpolation (also called full-color interpolation). Multi-channel interpolation can include estimating missing channels of image pixels based on known channel values of neighboring image pixels.

For example, and referring to FIG. 7, assume that camera pixel 171m has a red filter. Due to the red filter, camera pixel 171m can measure red light, but not blue or green light (although the photodiode(s) of camera pixel 171m can be capable of measuring blue or green light if camera 171m included a blue or green filter). Therefore, the image pixel mapped to camera pixel 171m would have a red channel, but not a green or blue channel.

Processing system 1800 can interpolate a blue channel for the image pixel by finding the average channel value of four neighboring blue channel image pixels. Similarly, processing system 1800 can estimate a green channel for the image pixel by finding the average channel value of four neighboring green channel image pixels. This multi-channel interpolation algorithm is only one example. Processing system 1800 can apply other techniques.

Processing system 1800 can interpolate until each image pixel includes a channel value for each channel of a predetermined color space. After multi-channel interpolation, processing system 1800 can store the multi-channel image in a stable state (e.g., as a JPEG).

Because an image can have millions of pixels, multi-channel interpolation can be computationally intensive. To accelerate multi-channel interpolation, processing system 1800 can include specialized features (also called multi-channel interpolators). Multi-channel interpolators can be specialized hardware (e.g., ASIC processors) and/or specialized software. Multi-channel interpolators are typically only compatible with image mosaics arranged in a particular spectral pattern.

Among other things, the present disclosure enables processing system 1800 to remosaic an image into a spectral pattern compatible with the multi-channel interpolators. In general, remosaicing can include converting a first mosaic of an image into a second mosaic of the image.

To achieve this result, processing system 1800 can read-out a first mosaic of an image from sensor panel 121. The first mosaic can have a spectral pattern matching the camera filter array 140 (e.g., a Quadra filter array 140). Readout can include analog to digital conversion, signal amplification, and the like.

After readout, and in some cases, directly after readout, processing system 1800 can remosaic the first mosaic into a second mosaic (further discussed below). The first mosaic can have a first spectral pattern (e.g., Quadra pattern 800). The second mosaic can have a second spectral pattern (e.g., Bayer pattern 700). The second spectral pattern can be compatible with the multi-channel interpolators.

Both the first and second mosaics can include the same image pixels. When in the first mosaic, each pixel can have a first channel (e.g., green) with a first channel value (e.g., 45). When in the second mosaic, each pixel can have a second channel (e.g., blue) with a second channel value (e.g., 60).

The first and second mosaics can have the same resolution (and thus the same pixels arranged in the same aspect ratio). Alternatively, the second mosaic can have a different resolution than the first mosaic. For example, the second mosaic can have a lower resolution that the first mosaic and thus include some, but not all, of the pixels in the first mosaic.

The present disclosure refers to static image pixels (also called frozen image pixels) and morphing image pixels (also called fluid image pixels). Static image pixels have equal first and second channels and therefore, can have equal first and second channel values. Morphing pixels can have different first and second channels. Morphing pixels are the subject of remosaicing interpolation, which can be different than multi-channel interpolation.

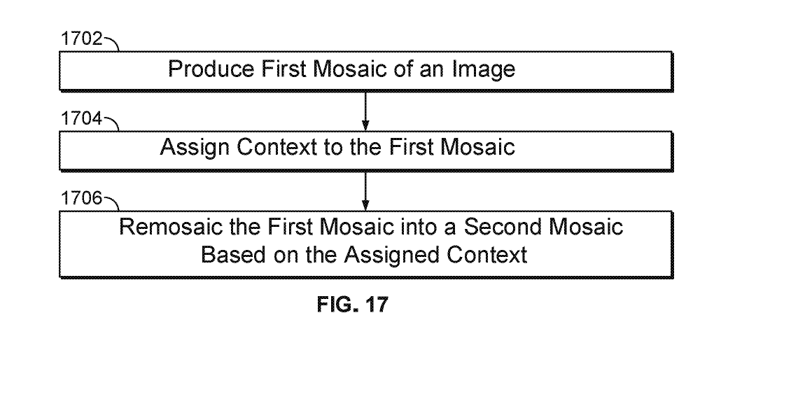

FIG. 17 is a block diagram of an example remosaicing method. Processing system 1800 can be configured to perform the method of FIG. 17. At block 1702, processing system 1800 can produce a first mosaic of an image. The first mosaic can have a first spectral pattern (e.g., a Quadra spectral pattern). When in the first mosaic state, each image pixel can have a first channel and a first channel value.

At block 1704, processing system 1800 can assign context to the first mosaic. Processing system 1800 can assign a single context to the entire first mosaic or assign a separate context to at least some of the image pixels in the first mosaic.

At block 1706, processing system 1800 can remosaic the first mosaic into a second mosaic based on the assigned context. The second mosaic can have a Bayer spectral pattern. After block 1706, processing system 1800 can save the second mosaic and/or perform multi-channel interpolation on the second mosaic.

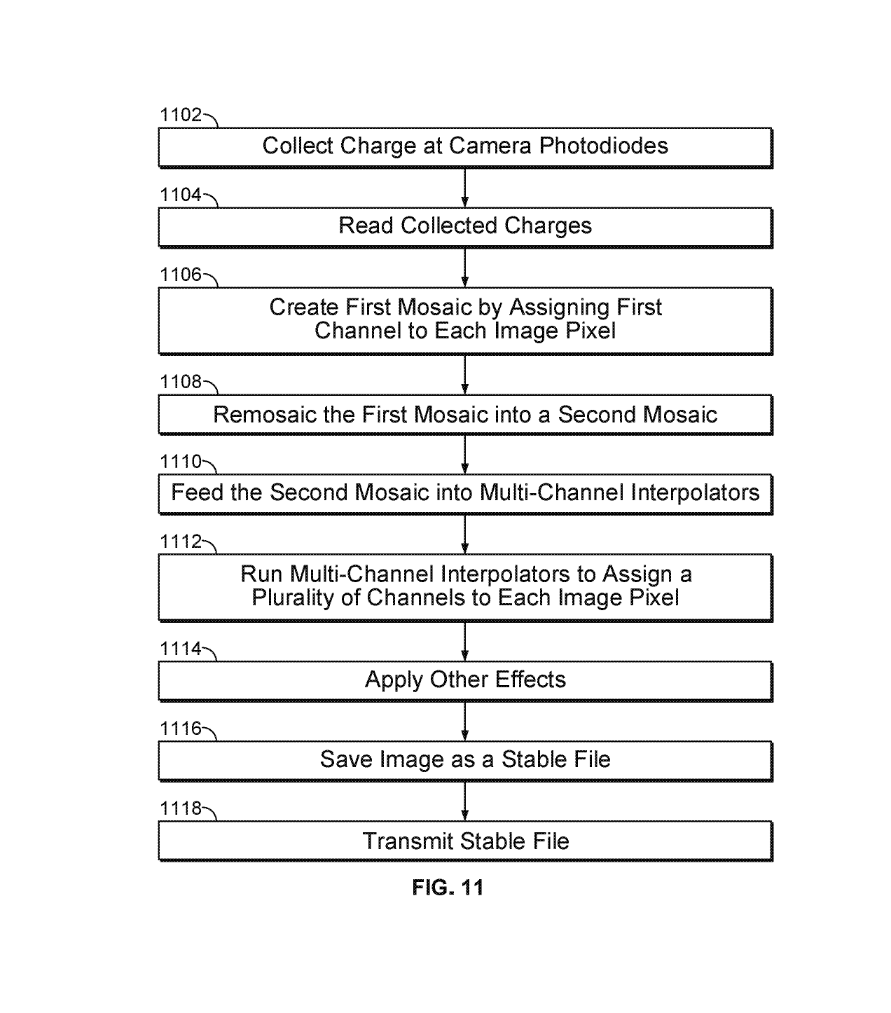

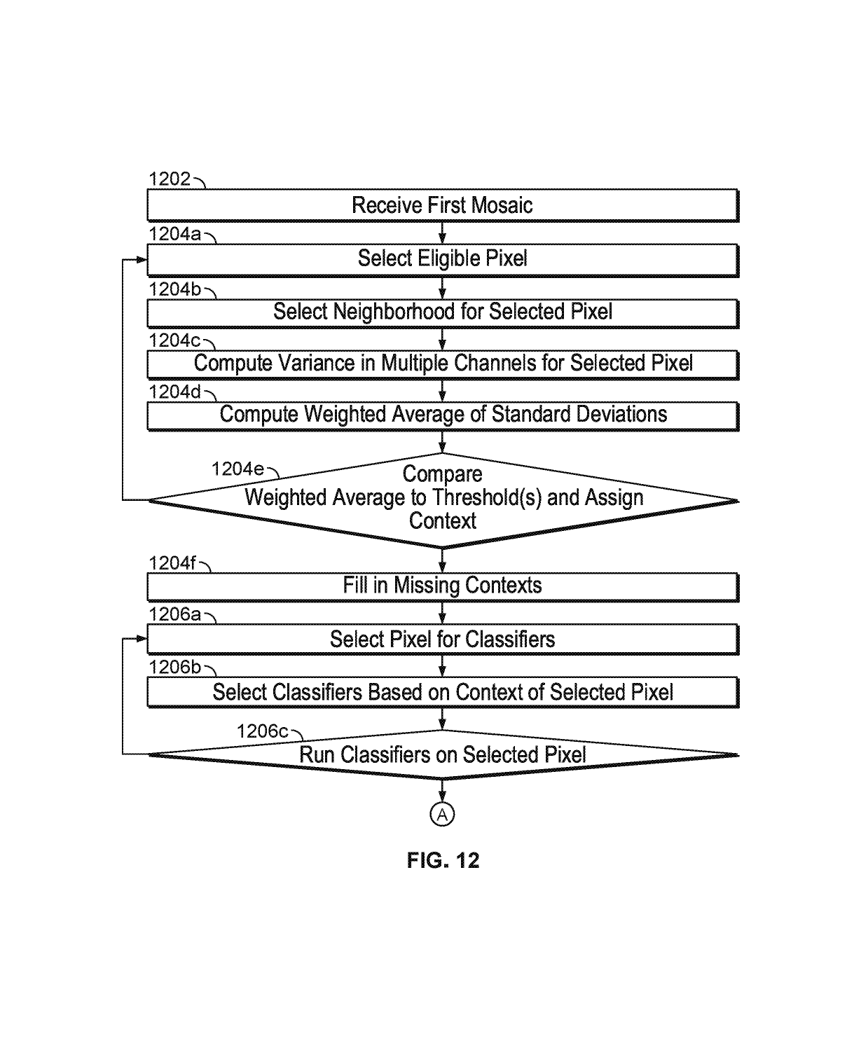

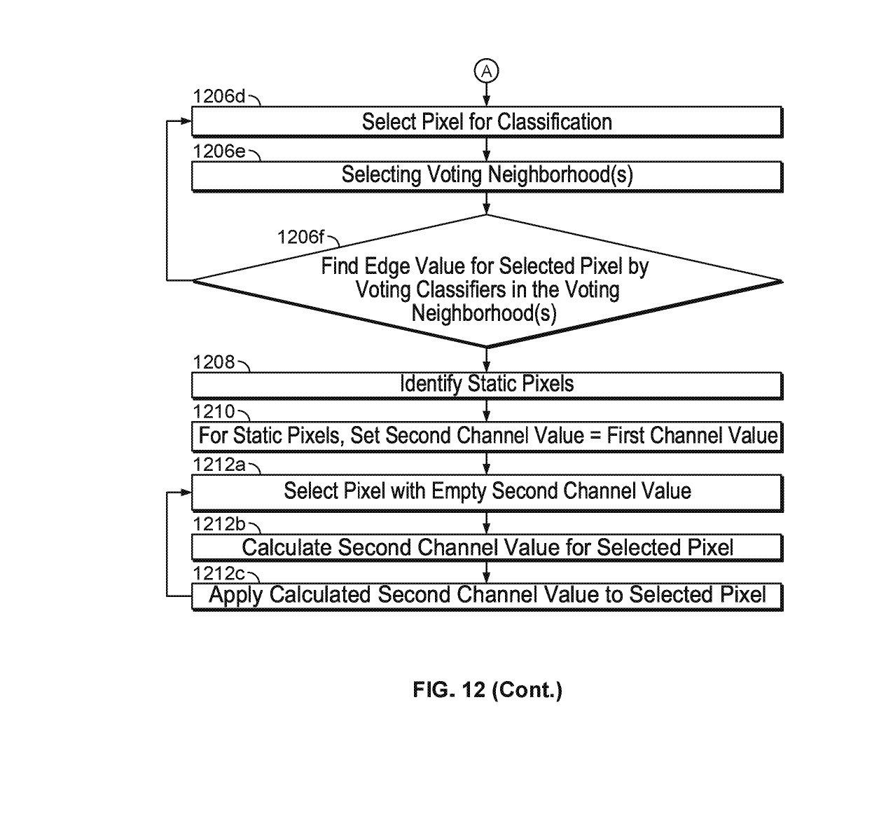

FIG. 11 is a block diagram of an example image file production (e.g., processing, generation, preparation) method. FIG. 12 is a block diagram of an example method of performing block 1108 of FIG. 11. Processing system 1800 can be configured to perform some or all of these methods. Some examples of the methods of FIGS. 11 and 12 can omit blocks. Some examples can reorder blocks. According to some examples, the method of FIG. 17 can be implemented through the methods of FIGS. 11 and 12.

For illustrative purposes, the below discussion of FIGS. 11, and 12 uses the example of a first mosaic with a Quadra spectral pattern 800 and a second mosaic with a Bayer spectral pattern 700. But the disclosed methods can be applied to any two spectral patterns (e.g., RGB-IR 1000 and Quadra 800).

The disclosed algorithms can be modified for boundary-condition pixels (e.g., pixels along the edges of sensor panel 121). According to some examples, boundary-condition pixels can apply the same disclosed algorithms, but omit portions thereof referencing non-existent image pixels (e.g., non-existent neighbors of pixels along the edges of sensor panel 121).

FIG. 11 shows one example of an image production method that includes remosaicing. FIG. 12A shows a first method of remosaicing. FIG. 12B shows a second method of remosaicing. The methods of FIGS. 12A and/or 12B can be performed during block 1108 of FIG. 11. The methods of FIGS. 12A and/or 12B can be performed during methods other than the method of FIG. 11.

At block 1102, camera pixels 171 can collect charge (e.g., electrons) as light 301 incident on photodiodes 161 creates photocurrent. At block 1104, processing system 1800 can read out the charge level of each photodiode 161 in each camera pixel 171 (e.g., via a rolling readout, a global readout, etc.).

At block 1106, processing system 1800 can produce (e.g., prepare, process, generate, create) the first mosaic. Processing system 1800 can assign a first channel to each image pixel based on the known filter 141 of the corresponding camera pixel 171. For example, processing system 1800 can assign green first channels to image pixels mapping to camera pixels 171 with green filters 141, and so on.

Processing system 1800 can assign a first channel value to each image pixel based on the one or more charge levels captured by the one or more photodiodes 161 in the camera pixel 171 mapping to the image pixel. Therefore, the first mosaic can have a spectral pattern matching the spectral pattern of the filter array 140. To account for photodiode readout circuitry in sensor panel 121, the first mosaic can have a slightly different layout than the filter array 140.

At block 1108, and as further discussed below, processing system 1800 can remosaic the first mosaic into a second mosaic. At block 1110, processing system 1800 feeds the second mosaic into the multi-channel interpolators. At block 1112, processing system 1800 can run the multi-channel interpolators to assign a plurality of predetermined channels to each image pixel. The predetermined channels can be red, green, and blue; red, green, blue, and infrared; and the like. The predetermined channels can reflect a desired color space of the image (e.g., CIE, RGB, etc.).

At block 1114, processing system 1800 can apply additional effects (e.g., gamma correction) to the multi-channel image. Alternatively, or in addition, these effects can be applied at other stages of the method (e.g., before block 1114). At block 1116, processing system 1800 can save the multi-channel image as a stable file in non-volatile memory (e.g., as a JPEG, a TIFF, a BMP, a BPG) and/or present (e.g., display) the image (e.g., present a downsample of the image). The stable image file can be lossless or lossy. At block 1118, processing system 1800 can transmit the image (e.g., over the Internet via a wireless connection).

To improve energy efficiency and remosaicing accuracy, processing system 1800 can remosaic based on context. The context can be one or more statistical measurements of the first mosaic. According to some examples, statistical measurements such as variance and/or standard deviation, computed for a plurality of pixels of the first mosaic, can serve as context.

FIG. 12 is a block diagram of an example remosaicing method. Processing system 1800 can be configured to perform some or all of the operations associated with the example remosaicing method. According to some examples, the example remosaicing method occurs at block 1108 in the example image file production method of FIG. 11.

The method of FIG. 12 can include: (a) finding a context of the first mosaic, (b) selecting one or more classifiers based on the context, (c) running the selected classifiers on the first mosaic, (d) estimating edge directions based on results of the selected classifiers, and (e) producing the second mosaic by interpolating based on the estimated edge directions.

The single-channel interpolating discussed with reference to FIG. 12 can be different from the multi-channel interpolating discussed with reference to FIG. 11.

At block 1202, processing system 1800 can receive the first mosaic. The first mosaic can be arranged in the first spectral pattern. Each image pixel of the first mosaic can have a single channel (and thus a single channel value).

At blocks 1204a-1204f, processing system 1800 can assign a context to the first mosaic. According to some examples, processing system 1800 assigns context based on a degree of structure in the image. A low degree of structure can result in a first context. A high degree of structure can result in a second context. Processing system 1800 can approximate structure with statistical analysis.

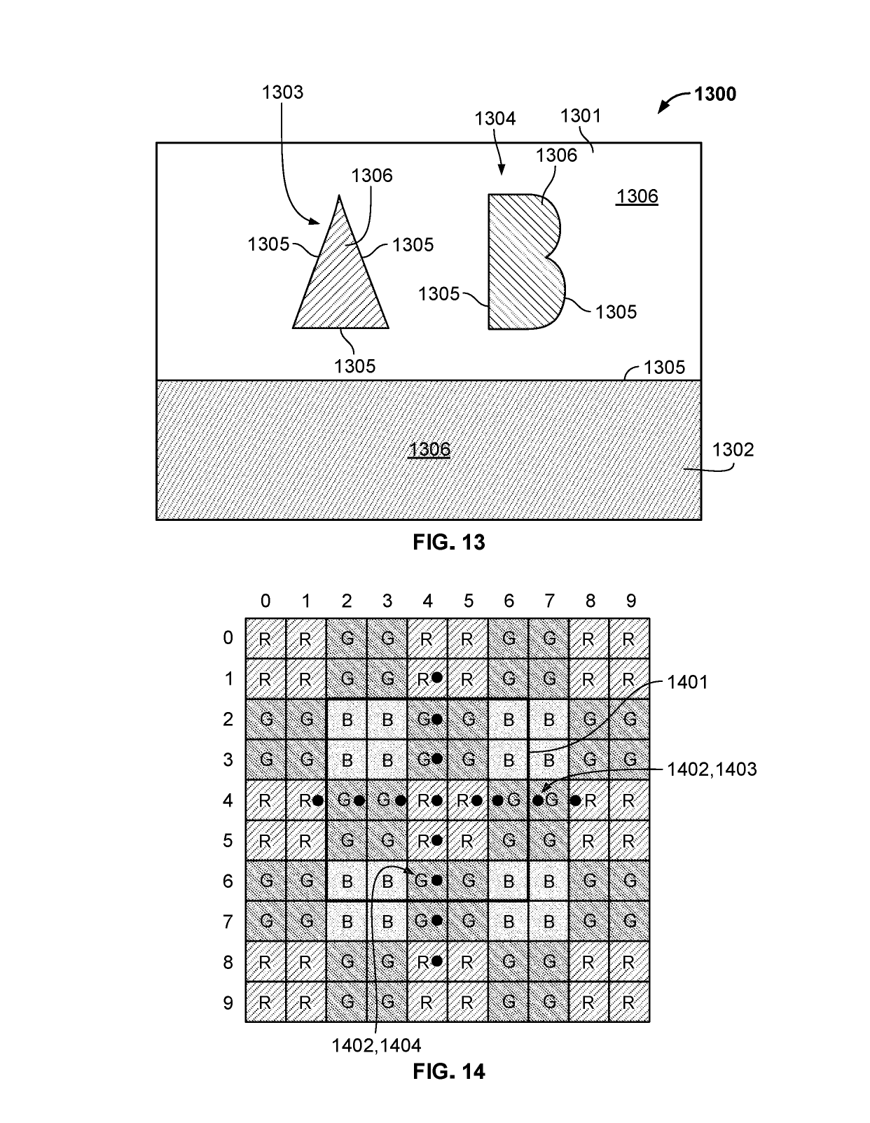

FIG. 13 shows a scene 1300. Smooth wall 1301 meets a smooth floor 1302. Object A 1303 and Object B 1304 are posed in front of wall 1301. Wall 1301 has a first color (e.g., white). Floor 1302 has a second color (e.g., gray). Object A 1303 has a third color (e.g., red). Object B 1304 has a fourth color (e.g., blue). An image of scene 1300 should therefore include edges 1305 and color fields 1306. In this example, edges 1305 define outer boundaries of different color fields 1306. Remosaicing can estimate the location of edges 1305 to reduce remosiacing interpolation between different color fields 1306.

During remosaicing and according to this example, processing system 1800 will ideally interpolate second channel values for image pixels in any particular color field 1306 based on first channel values of other image pixels in the same color field 1306. This is because interpolation across edges 1305 results in undesirable artifacts. For example, if processing system 1800 interpolated (e.g., derived) second channel values for image pixels defining wall 1301 based on first channel values for image pixels defining object A 1303, then the wall would likely include a reddish patch, representing an artifact.

Because an image exists as a first mosaic at block 1204, processing system 1800 cannot precisely identify locations of edges 1305 and color fields 1306. Instead, processing system 1800 can assume that edges 1305 exist (or are likely to exist) in portions of the first mosaic with a high degree of structure and can assume that color fields 1306 exist (or are likely to exist) in portions of the first mosaic with a low degree of structure.

To estimate degree of structure, and therefore context, processing system 1800 can perform one or more statistical analyses on the first mosaic. The statistical analyses can be a variance and/or standard deviation calculations. Although variance is discussed below, other forms of statistical analyses can be applied (e.g., entropy calculations).

Referring to FIG. 12, and at block 1204a, processing system 1800 can select an eligible image pixel (i.e., an image pixel that is suitable to be processed) in the first mosaic. Because block 1204a can repeat, processing system 1800 can ultimately (e.g., after multiple iterations) select a plurality of different eligible image pixels. According to some examples, block 1204a repeats until each eligible image pixel has been selected.

According to some examples, every image pixel in the first mosaic is eligible. According to other examples, only a subset of image pixels are eligible. For example: only morphing image pixels with a green second channel can be eligible; only morphing image pixels with one or more predetermined second channels can be eligible; only a random sample of image pixels can be eligible; only image pixels falling at predetermined intervals can be eligible; only pixels satisfying two or more of the preceding eligibility rules can be eligible; etc.

At block 1204b, processing system 1800 can select (e.g., determine) a neighborhood for the selected image pixel. According to some examples, the neighborhood has a predetermined size and/or shape. FIG. 14 shows a selected image pixel with coordinates (4,4). As shown in FIG. 14, the neighborhood can be a rectangle 1401 (e.g., a square) of image pixels centered on the selected image pixel.

Alternatively or in addition, the neighborhood can be a cross of image pixels 1402 (represented by image pixels with black dots). The cross can include a horizontal component 1403 and a vertical component 1404, which intersect at the selected image pixel. The selected image pixel can be, but does not need to be, part of the neighborhood.

At block 1204c, processing system 1800 can compute variance in multiple channels for the selected image pixels. For example, processing system 1800 can find multiple variances for the selected image pixel based on the selected neighborhood: o_{s,c}²=Σ_{N}[(cv_{c}(x,y)−μ)²]. According to this equation, variance is “o_{s,c}²”, “s” is the selected image pixel, “c” is a particular channel; “N” is the selected neighborhood; “cv_{c}(x,y)” is the first channel value of an image pixel in the neighborhood with first channel “c”; “μ” is the average first channel value of all image pixels in the neighborhood with first channel “c”.

The above equation references “c” because the equation can be performed for each first channel (i.e., each channel in the first mosaic) or can be performed for each second channel (i.e., each channel in the second mosaic). Therefore, if the first mosaic has a Quadra pattern 800 and the second mosaic has a Bayer pattern 700, then the variance can be calculated three times for each selected image pixel: once when “c” is green, when “c” is blue, and once when “c” is red.

During the variance calculation, image pixels in the selected neighborhood with a channel other than “c” can be ignored. For example, if five image pixels in a selected neighborhood have a red first channel, then those five image pixels can be ignored for the green channel and blue channel variance calculations. As a result, the average channel value “μ” can be the average of image pixels with the “c” channel.

At block 1204d, processing system 1800 can find a weighted average of square roots of the multiple variances. The square root of a variance is a standard deviation. Both the standard deviation and the variance can approximate how different or similar channel values are in a certain neighborhood of image pixels. Alternatively or in addition, processing system 1800 can find a weighted average of the multiple variances (each variance being for a different channel) computed for the selected image pixel.

Therefore, processing system 1800 can take the square root of each variance to yield a standard deviation, then find a weighted average of the multiple standard deviations (each standard deviation being for a different channel). The average can weight each channel equally. The average can assign a greater weight to the standard deviation associated with the green channel since human eyes are typically more sensitive to green light than red light or blue light.

At block 1204e, processing system 1800 can compare the weighted average to one or more predetermined thresholds, ordered in increasing size (e.g., the second predetermined threshold is greater than the first predetermined threshold, the third predetermined threshold is greater than the second predetermined threshold, and so on).

If the weighted average is less than the first predetermined threshold, then processing system 1800 can assign a first context to the selected image pixel. If the weighted average is (a) greater than or equal to the first predetermined threshold and (b) less than the second predetermined threshold (if multiple thresholds exist; some examples can only have a single threshold), then processing system 1800 can assign a second context to the selected image pixel.

Processing system 1800 can continue for each predetermined threshold, until reaching the maximum predetermined threshold. If the weighted average is greater than or equal to the maximum predetermined threshold, then processing system 1800 can assign a maximum context to the image pixel.

According to some examples, processing system 1800 only assigns the calculated context to the selected image pixel. According to other examples, processing system 1800 can (a) assign the context to all image pixels within the neighborhood or (b) assign the context to an inner patch of the neighborhood (e.g., if the neighborhood is a 5×5 patch, then image pixels in a 2×2 patch centered in the 5×5 patch can be assigned the first context).

After block 1204e, processing system 1800 can return to block 1204a to select a new eligible image pixel. Processing system 1800 can cycle through blocks 1204a-1204e until each eligible image pixel is paired with a context. If blocks 1204a-1204e result in a context assignment for a plurality of image pixels, processing system 1800 can select new image pixels at block 1204a such that no image pixel is assigned a context more than once.

If not all image pixels in the first mosaic receive a context (e.g., due to skipping image pixels according to predetermined intervals or sampling), then processing system 1800 can perform block 1204f to fill in missing contexts. During block 1204f, processing system 1800 can (a) automatically assign the first context to the remaining image pixels or (b) interpolate a context for each remaining image pixel based on an average of the contexts calculated according to blocks 1204a-1204e surrounding the remaining image pixel. The average can be a weighted average, where each calculated context is weighted according to an inverse of its spatial distance from the remaining image pixel.

At blocks 1206a-1206f, processing system 1800 can classify the first mosaic with one or more classifiers, based on the context of the first mosaic. At block 1206a, processing system 1800 can select an image pixel in the first mosaic to run classifiers on. Because block 1206a can repeat, processing system 1800 can ultimately select a plurality of image pixels (e.g., after a plurality of iterations). According to some examples, block 1206a repeats until each eligible image pixel has been selected.

According to some examples, every image pixel in the first mosaic is eligible. According to other examples, only a subset of image pixels are eligible. For example: only morphing image pixels with a green second channel can be eligible; only morphing image pixels with one or more predetermined second channels can be eligible; only pixels with a context can be eligible; only pixels satisfying two or more of the preceding eligibility rules can be eligible; etc.

At block 1206b, processing system 1800 can select one or more classifiers for the selected image pixel based on (a) the context assigned to the selected image pixel and (b) the first channel of the selected image pixel. Processing system 1800 can further select the classifiers based on (c) the second channel of the selected image pixel and/or (d) the position of the selected image pixel. If the selected image pixel does not have a context, then processing system 1800 can proceed as if the selected image pixel was assigned a first context.

The classifiers can be gradient classifiers (e.g., gradient calculation algorithms). The gradient classifiers can be same-channel gradient classifiers and/or cross-channel gradient classifiers. Each classifier can have a horizontal component and a vertical component.

According to some examples, processing system 1800 applies a greater number of classifiers to image pixels with a higher context, all else being equal. Alternatively or in addition, processing system 1800 applies classifiers with a greater kernel size to image pixels with a higher context, all else being equal.

For example, processing system 1800 can select “N” classifiers for red first channel image pixels with no context and/or a first context, where “N” is a predetermined number of classifiers. Processing system 1800 can select “N”+“X” classifiers for red first channel image pixels with a second or greater context, where “X” is a variable number of classifiers that increases with context. Processing system 1800 can select one or more classifiers with an enhanced kernel size for red image pixels with a second or greater context, where the kernel size increases with context.

As a result, for any given selected image pixel, the selected classifier with the greatest kernel size can be (a) a first value when the context is absent and/or the context is one and (b) a value exceeding the first value when the context is two or more.

Processing system 1800 can be configured such that for any selected image pixel, classifiers consider “A” unique image pixels neighboring the selected image pixel when the selected image pixel has no context and/or a first context and “B” unique image pixels neighboring the selected image pixel when the selected image pixel has a second or greater context, where “B” varies with the degree of context, but is greater than “A”. The same concepts can apply to blue and/or infrared image pixels. The same concepts can apply to green image pixels.

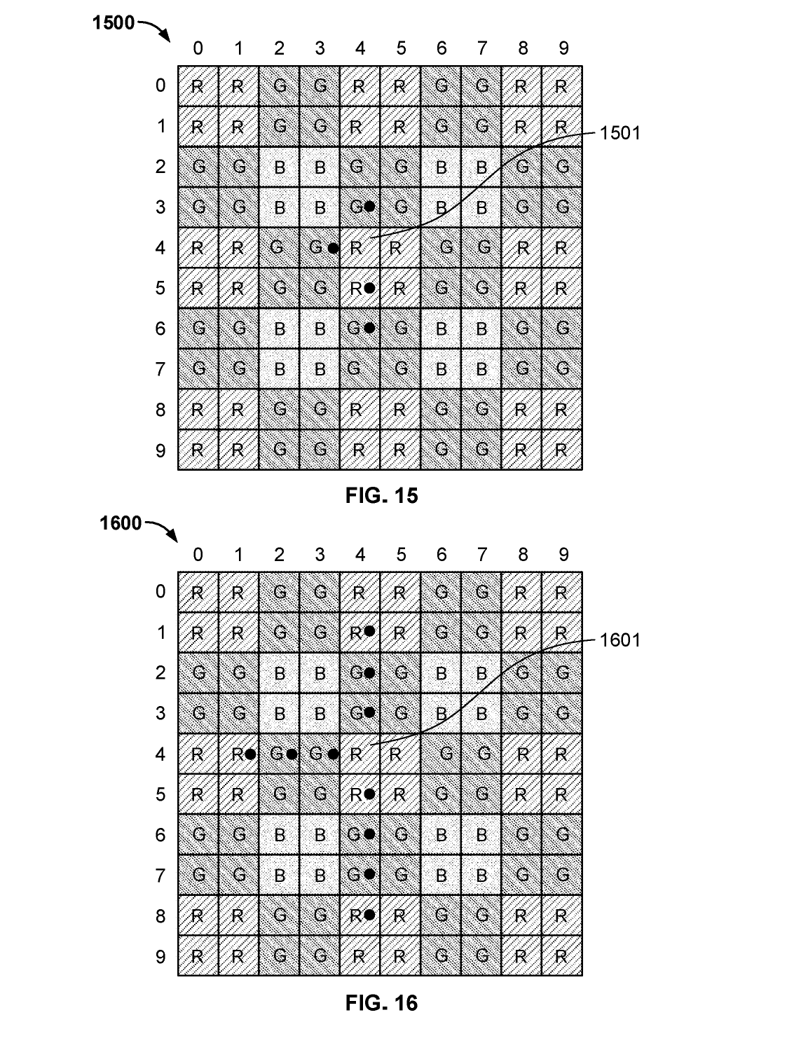

FIG. 15 shows a first mosaic 1500, which has a Quadra spectral pattern 800. Processing system 1800 has selected red first channel image pixel 1501 having a first context or no context and coordinates (4,4). FIG. 16 shows a second mosaic 1600, which has a Quadra spectral pattern 800. Processing system 1800 has selected red first channel image pixel 1601 having a second context and coordinates (4,4).

Referring to FIG. 15, processing system 1800 has applied a same-channel gradient classifier with a kernel size of seven image pixels. The image pixels within the kernel are dotted. Processing system 1800 can break the same-channel gradient classifier into a horizontal component and a vertical component. According to some examples, G_{vertical}=abs[cv(4,4)−cv(4,5)+cv(4,6)−cv(4,3)], where “abs” means “absolute value of” and cv(x,y) means channel value of the image pixel at coordinates (x,y). According to some examples, G_{horizontal}=abs[cv(4,4)−cv(5,4)+cv(6,4)−cv(3,4)].

Processing system 1800 can apply a different kernel size to find the cross-channel gradient of red image pixel 1501. Not all image pixels in the kernel need to be directly adjacent.

FIG. 16 shows fifteen different dotted pixels. The dotted pixels can be part of one or more kernels, as illustrated with the following examples.

According to example (a), processing system 1800 is configured to apply a same-channel gradient classifier with a kernel size of fifteen image pixels.

According to example (b), processing system 1800 is configured to apply (i) a same-channel gradient classifier with a kernel size of seven image pixels and (ii) a second same-channel gradient classifier with a kernel size of eight image pixels.

According to example (c), processing system 1800 is configured to apply (i) same-channel gradient classifier with a kernel size of seven image pixels and (ii) a second same-channel gradient classifier with a kernel size of fifteen image pixels.

According to example (d), processing system 1800 is configured to apply (i) a first same-channel gradient classifier with a kernel size of seven image pixels, (ii) a second same-channel gradient classifier with a kernel size of eight image pixels, and (iii) a third same-channel gradient classifier with a kernel size of fifteen image pixels.

Irrespective of whether processing system 1800 is configured to perform example (a), (b), (c), or (d), the exemplary same channel gradient classifier of FIG. 16 considers fifteen unique image pixels, while the exemplary same channel gradient classifier of FIG. 15 considers seven unique image pixels.

According to examples (a), (c), and (d) the same-channel gradient algorithm with a kernel size of fifteen image pixels can be broken into a horizontal component and a vertical component: According to some examples, G_{vertical}=abs[cv(4,4)−cv(4,5)+cv(4,6)−cv(4,3)+cv(4,7)−cv(4,2)+cv(4,8)−cv (4,1)]. According to some examples, G_{horizontal}=abs[cv(4,4)−cv(5,4)+cv(6,4)−cv(3,4)+cv(7,4)−cv(2,4)+cv(8,4)−cv(1,4)].

According to examples (b), (c), and (d), the same-channel gradient algorithm with a kernel size of seven image pixels can be the same as discussed with reference to FIG. 15.

According to examples (b) and (d), the same-channel gradient algorithm with a kernel size of eight image pixels can be broken into a horizontal and a vertical component: According to some examples, G_{vertical}=abs[cv(4,7)−cv(4,2)+cv(4,8)−cv (4,1)]. According to some examples, G_{horizontal}=abs[cv(7,4)−cv(2,4)+cv(8,4)−cv(1,4)].

According to some examples, processing system 1800 applies a maximum kernel size of “X” for each image pixel with a first or no context (irrespective of its location [except for boundary conditions] and channel) for same channel gradient and a maximum kernel size of “Y” for each image pixel with a first or no context (irrespective of its location [except for boundary conditions] and channel) for cross channel gradient, where “X”≥“Y”.

According to some examples, processing system 1800 applies a maximum kernel size of “X”+“Q” for each image pixel with a second or greater context (irrespective of its location or color) for same channel gradient and a maximum kernel size of “Y”+“R” for each image pixel with a second or great context. Both “Q” and “R” can be positively correlated with context (e.g., “Q” for a second context is less than “Q” for a third context and so on). At any given context level, “Q” and “R” can be equal.

Referring to FIG. 12, at block 1206c, processing system 1800 can run the selected classifiers (e.g., the selected gradient calculation algorithms). Processing system 1800 can cycle through blocks 1206a-1206c until each image pixel eligible for selection has (a) a same-channel horizontal gradient, (b) a same-channel vertical gradient, (c) a cross-channel horizontal gradient, and (d) a cross-channel vertical gradient.

At block 1206d, processing system 1800 can select an image pixel for classification based on outcomes of the classifiers. Because block 1206d can repeat, processing system 1800 can ultimately select a plurality of image pixels (e.g., after a plurality of iterations). According to some examples, block 1206d repeats until each eligible image pixel has been selected.

According to some examples, every image pixel in the first mosaic is eligible. According to other examples, only a subset of image pixels are eligible. For example: only morphing image pixels with a green second channel can be eligible; only morphing image pixels with one or more predetermined second channels can be eligible; etc.

At block 1206e, processing system 1800 can select a voting neighborhood for the selected image pixel. According to some examples, the voting neighborhood is fixed. According to some examples, a first voting neighborhood is used for same channel classifiers and a second voting neighborhood is used for cross channel classifiers, where the first and second voting neighborhoods only partially overlap (i.e., the first and second voting neighborhoods have some, but not all, image pixels in common). According to some examples, a size of the first voting neighborhood exceeds a size of the second voting neighborhood and the selected image pixel is part of both neighborhoods.

At block 1206f, processing system 1800 can find an edge value, ß, for the selected image pixel by voting comparisons of horizontal and vertical gradients for each image pixel in the first neighborhood and for each image pixel in the second neighborhood. This is also referred to as voting the classifiers in the first and second neighborhoods. Put differently, edge value, ß, can be based on the horizontal and vertical gradient for each image pixel in the first neighborhood and each image pixel in the second neighborhood.

Edge value, ß, can be computed such that it occupies the range [0, 1] (inclusive), where 0 conveys a likely horizontal edge, 0.5 conveys a likely diagonal edge, and 1 conveys a likely vertical edge. The processing of computing an edge value, ß, can represent estimating an edge direction.

Processing system 1800 can cycle through blocks 1206d-1206f until each selection eligible image pixel (which can be all image pixels or only a portion as described above with reference to block 1206d) has an edge value, ß. According to some examples, (a) all image pixels in the first mosaic are assigned a first context or a second context; (b) classifiers are applied to each image pixel in the first mosaic based on the image pixel's context; (c) an edge value, ß, is only found (via blocks 1206d-1206f) for image pixels with a non-green first channel and a green second channel.

At block 1208, processing system 1800 can identify (e.g., via a predetermined list) static image pixels, which, as described above, have equal first and second channels along with equal first and second channel values. At block 1210, processing system 1800 can, for each identified static image pixel, set the second channel value as equal to the first channel value.

At blocks 1212a-1212c, processing system 1800 can complete the second mosaic by finding the second channel values of morphing image pixels. At block 1212a, processing system 1800 can select a morphing image pixel without a second channel value. At block 1212b, processing system 1800 can calculate the second channel value for the selected image pixel:

$$CV {2}_{( x , y )} = ( 1 - β ) \frac{( 1 / A ) * CV 1 ( x 1 , y ) + ( 1 / B ) * CV 1 ( x 2 , y )}{( 1 / A ) + ( 1 / B )} + ( β ) \frac{( 1 / C ) * CV 1 ( x , y 1 ) + ( 1 / D ) * CV 1 ( x , y 2 )}{( 1 / C ) + ( 1 / D )} .$$

Any variables to the left side of the “=” sign refer to the second mosaic (i.e., second values) while any variables to the right side of the “=” sign refer to the first mosaic (i.e., first values). CV2(x,y) is the second channel value for the selected image pixel, which is located at (x,y). As discussed above, ß is the edge value for the morphing image pixel.

CV1(x1, y) is the first channel value of the image pixel that (a) is horizontally nearest the selected morphing image pixel and (b) has a first channel equal to the second channel of the selected morphing image pixel. “A” is the distance (in units of image pixels) of the (x1, y) image pixel from the selected image pixel. CV1(x2, y) is the first channel value of the image pixel that (a) is horizontally nearest the selected morphing image pixel, but in an opposite horizontal direction and (b) has the same channel as the selected morphing image pixel in the second mosaic.

Opposite horizontal direction means that (x,y) must be in between (x1, y) and (x2, y) such that if (x1, y) is to the left of (x, y), then (x2, y) must be to the right of (x, y) and if (x1, y) is to the right of (x, y), then (x2, y) must be to the left of (x, y). “B” is the distance (in units of image pixels) of the (x2, y) image pixel from the selected morphing image pixel. Similar concepts apply to CV1(x, y1), “C”, CV1(x, y2), and “D”, except the vertical replaces horizontal, and top/bottom replace left/right.

According to some examples, only morphing image pixels having a green second channel are modified by a variable edge value, B. Other morphing image pixels (e.g., image pixels morphing to a blue or red second channel) can substitute 0.5 for B.

At block 1212c, processing system 1800 can fill in the second channel value of the selected image pixel. After block 1212c, processing system 1800 can return to block 1212a, until every morphing image pixel has a second channel value.

According to some examples, blocks 1208 and 1210, which relate to static image pixels, can occur after block 1212. According to some examples, processing system 1800 can select each image pixel row-by-row or column-by-column and determine whether the image pixel is static or morphing. Processing system 1800 can apply block 1210 if the image pixel is static and apply blocks 1212b and 1212c if the image pixel is morphing. Afterwards, processing system 1800 can select the next image pixel in the row/column.

Once the second mosaic is complete (e.g., each image pixel in the image has a single second channel value found via copying or interpolation), processing system 1800 can proceed to block 1110 of FIG. 11.

Mobile device 100 can be a smartphone 100a, a tablet, a digital camera, or a laptop. Mobile device 100 can be an Android® device, an Apple® device (e.g., an iPhone®, an iPad®, or a Macbook®), or Microsoft® device (e.g., a Surface Book®, a Windows® phone, or Windows® desktop). Mobile device 100 can be a camera assembly 100b. Mobile device 100 can be mounted to a larger structure (e.g., a vehicle or a house).

As schematically shown in FIG. 18, mobile device 100 (or any other device, such as a vehicle or desktop computer) can include a processing system 1800. Processing system 1800 can include one or more processors 1801, memory 1802, one or more input/output devices 1803, one or more sensors 1804, one or more user interfaces 1805, one or more motors/actuators 1806, and one or more data buses 1807.

Processors 1801 can include one or more distinct processors, each having one or more cores. Each of the distinct processors can have the same or different structure. Processors 1801 can include one or more central processing units (CPUs), one or more graphics processing units (GPUs), circuitry (e.g., application specific integrated circuits (ASICs)), digital signal processors (DSPs), and the like. Processors 1801 can be mounted on a common substrate or to different substrates.

Processors 1801 are configured to perform a certain function, method, or operation at least when one of the one or more of the distinct processors is capable of executing code, stored on memory 1802 embodying the function, method, or operation. Processors 1801 can be configured to perform any and all functions, methods, and operations disclosed herein. For example, when the present disclosure states that processing system 1800 can perform task “X”, such a statement should be understood to disclose that processing system 1800 can be configured to perform task “X”. Mobile device 100 and processing system 1800 are configured to perform a function, method, or operation at least when processors 1801 are configured to do the same.

Memory 1802 can include volatile memory, non-volatile memory, and any other medium capable of storing data. Each of the volatile memory, non-volatile memory, and any other type of memory can include multiple different memory devices, located at a multiple distinct locations and each having a different structure.

Examples of memory 1802 include a non-transitory computer-readable media such as RAM, ROM, flash memory, EEPROM, any kind of optical storage disk such as a DVD, a Blu-Ray® disc, magnetic storage, holographic storage, an HDD, an SSD, any medium that can be used to store program code in the form of instructions or data structures, and the like. Any and all of the methods, functions, and operations described in the present application can be fully embodied in the form of tangible and/or non-transitory machine readable code saved in memory 1802.

Input-output devices 1803 can include any component for trafficking data such as ports and telematics. Input-output devices 1803 can enable wired communication via USB®, DisplayPort®, HDMI®, Ethernet, and the like. Input-output devices 1803 can enable electronic, optical, magnetic, and holographic, communication with suitable memory 1803. Input-output devices can enable wireless communication via WiFi®, Bluetooth®, cellular (e.g., LTE®, CDMA®, GSM®, WiMax®, NFC®), GPS, and the like.

Sensors 1804 can capture physical measurements of environment and report the same to processors 1801. Sensors 1804 can include camera 101. Sensors 1804 can include multiple cameras 101. Each camera 101 can be configured to multi-channel interpolate via the same multi-channel interpolators. Each camera 101 can have a different filter array 140.

Therefore, processing system 1800 can be configured to apply a first remosaicing method to a first camera 101 and a second remosaicing method to a second camera 101. The first remosaicing method can begin with a first mosaic having a first unique spectral pattern. The second remosaicing method can begin with a second mosaicking having a second unique spectral pattern. The first and second unique spectral patterns can be different (e.g., Quadra 800 and RGB-IR 1000). The second mosaics produced by the first remosaicing method and the second remosaicing method can have the same spectral pattern (e.g., Bayer 700).

User interface 1805 can enable user interaction with imaging system 100. User interface 1805 can include displays (e.g., LED touchscreens (e.g., OLED touchscreens), physical buttons, speakers, microphones, keyboards, and the like. User interface 1805 can include display 102 and hard button 103.

Motors/actuators 1806 can enable processor 1801 to control mechanical or chemical forces. If camera 101 includes auto-focus, motors/actuators 1806 can move a lens along its optical axis to provide auto-focus.

Data bus 1807 can traffic data between the components of processing system 1800. Data bus 1807 can include conductive paths printed on, or otherwise applied to, a substrate (e.g., conductive paths on a logic board), SATA cables, coaxial cables, USB® cables, Ethernet cables, copper wires, and the like. Data bus 1807 can consist of logic board conductive paths Data bus 1807 can include a wireless communication pathway. Data bus 1807 can include a series of different wires 1807 (e.g., USB® cables) through which different components of processing system 1800 are connected.

We claim:

1. A method of image processing, the method comprising:
producing a first mosaic of an image, the first mosaic having a first spectral pattern;
assigning a context to the first mosaic;
classifying the first mosaic based on the assigned context;
producing a second mosaic of the image based on the classifying, the second mosaic having a second spectral pattern different than the first spectral pattern.

2. The method of claim 1, wherein the first mosaic comprises a plurality of image pixels;
when in the first mosaic, each image pixel having a first value of a first spectral channel, the first spectral pattern being an array of the first spectral channels.

3. The method of claim 2, wherein the second mosaic comprises the plurality of image pixels,
when in the second mosaic, each image pixel having a second value of a second spectral channel, the second spectral pattern being an array of the second spectral channels.

4. The method of claim 3, wherein the plurality of pixels comprises a plurality of stable image pixels and a plurality of morphing image pixels;
wherein for each stable image pixel, the first spectral channel is equal to the second spectral channel; and
wherein for each morphing image pixel, the first spectral channel is different than the second spectral channel.

5. The method of claim 1, wherein the second spectral pattern is a Bayer pattern and the first spectral pattern is a non-Bayer pattern.

6. The method of claim 5, wherein the non-Bayer first spectral pattern is selected from the group consisting of: a Quadra pattern, an RGB with Infrared pattern, and a Bayer with Phase Detection pattern.

7. The method of claim 3, wherein classifying the first mosaic based on the assigned context comprises:
selecting one or more gradient classifiers based on the assigned context;
applying the one or more gradient classifiers to the first mosaic; and
estimating an edge direction in the first mosaic based on an outcome of the applied gradient classifiers.

8. The method of claim 7, wherein producing the second mosaic based on the classifying comprises:
assigning the second value to at least one of the image pixels by interpolating with a plurality of the first values, the interpolating relying on the estimated edge direction.

9. The method of claim 7, wherein producing the second mosaic based on the classifying comprises:
for at least one of the image pixels: assigning the second value by interpolating with a plurality of the first values, the interpolating relying on the estimated edge direction;
for at least another of the image pixels: assigning the second value without interpolating.

10. The method of claim 1, wherein assigning the context to the first mosaic comprises:
performing a plurality of statistical analyses on the first mosaic; and
assigning the context to the first mosaic based on the plurality of statistical analyses.

11. The method of claim 10, wherein the statistical analyses comprise at least one of a variance calculation and a standard deviation calculation.

12. The method of claim 3, wherein assigning the context to the first mosaic comprises:
performing a first statistical analysis on a first neighborhood of the first mosaic and a second statistical analysis on a second neighborhood of the first mosaic, the first and second neighborhoods comprising at least one common image pixel and at least one different image pixel.

13. The method of claim 12, wherein the first spectral pattern comprises a plurality of spectral channels and the first statistical analysis comprises an independent variance or standard deviation calculation for the each of the plurality of spectral channels of the first spectral pattern.

14. The method of claim 12, wherein classifying the first mosaic based on the context comprises:
based on an outcome of the first statistical analysis, selecting a first classifier having a first kernel size;
based on an outcome of the second statistical analysis, selecting a second classifier having a second kernel size, the second kernel size exceeding the first kernel size;
applying the first classifier to a first image pixel of the first mosaic;
applying the second classifier to a second image pixel of the first mosaic.

15. The method of claim 14, wherein the first spectral channel of the first image pixel is equal to the first spectral channel of the second image pixel, and the second spectral channel of the first image pixel is equal to the second spectral channel of the second image pixel.

16. The method of claim 1, wherein the first mosaic comprises a plurality of pixels and the second mosaic comprises the plurality of image pixels, each image pixel having a single first spectral channel when in the first mosaic and a single second spectral channel when in the second mosaic, the method comprising:
performing a full-color interpolation on the second mosaic until each of the plurality of image pixels has a plurality of spectral channels.

17. A processing system for imaging, the processing system comprising one or more processors configured to:
produce a first mosaic of an image based on metrics captured by an image sensor, the first mosaic having a first spectral pattern;
assign a plurality of contexts to the first mosaic;
classify the first mosaic based on the plurality of contexts;
produce a second mosaic of the image based on the classification, the second mosaic having a second spectral pattern, the first spectral pattern being different than the second spectral pattern.

18. The system of claim 17, wherein the first mosaic comprises a plurality of image pixels and the second mosaic comprises the plurality of image pixels;
the processors being configured to:
produce the first mosaic such that each of the plurality of image pixels has a first spectral channel, an array of each of the first spectral channels defining the first spectral pattern;
produce the second mosaic such that each of the plurality of image pixels has a second spectral channel, an array of each of the second spectral channels defining the second spectral pattern.

19. The system of claim 18, wherein the processing system comprises a camera, the camera comprising:
a lens and the image sensor, the image sensor comprising a plurality of camera pixels, each of the plurality of camera pixels comprising a spectral filter covering at least one photodiode;
wherein an array of the spectral filters matches the first spectral pattern.

20. The system of claim 17, wherein the first mosaic comprises a plurality of image pixels having first spectral channels and the second mosaic comprises the plurality of image pixels having second spectral channels, the one or more processors being configured to:
assign the plurality of contexts to the first mosaic such that each of the plurality of image pixels, when in the first mosaic, has a context.

21. The system of claim 20, wherein the one or more processors are configured to, for each of the plurality of image pixels:
select the image pixel;
select a neighborhood for the selected image pixel, the neighborhood comprising the selected image pixel and neighboring image pixels;
compute at least one of a variance and a standard deviation over the selected neighborhood;
assign at least one of the plurality of contexts to the selected image pixel, the at least one assigned context being based on the computed variance or standard deviation.

22. The system of claim 21, wherein the one or more processors are configured to classify the first mosaic based on the plurality of contexts by, for each of the plurality of image pixels:
selecting the image pixel;
selecting a classifier for the selected image pixel based on the context assigned to the selected image pixel;
running the classifier on a kernel of image pixels, the kernel of image pixels comprising the selected image pixel;
assigning an outcome of the classifier to the selected image pixel.

23. The system of claim 22, wherein the one or more processors are configured to classify the first mosaic by:
selecting each of a subset of the plurality of image pixels;
for each selected image pixel in the subset:
classifying the selected image pixel based on the classifier outcome assigned to the selected image pixel and at least one classifier outcome assigned to an image pixel neighboring the selected image pixel.

24. The system of claim 23, wherein the one or more processors are configured to:
classify image pixels within the subset and not classify image pixels outside the subset.

25. The system of claim 24, wherein the subset consists of image pixels having a non-green first spectral channel and a green second spectral channel.

26. A processing system for imaging, the processing system comprising:
means for producing a first mosaic of an image, the first mosaic being arranged in a first spectral pattern, the first mosaic comprising a plurality of image pixels, each of the plurality of image pixels having a first spectral channel when in the first mosaic;
means for (a) assigning a first context some image pixels in the first mosaic and (b) a second context to other image pixels in the first mosaic;
means for classifying the first mosaic based on first and second assigned contexts;
means for producing a second mosaic of the image based on the classifying, the second mosaic being arranged in a second spectral pattern, the second mosaic comprising the plurality of image pixels, each of the plurality of image pixels having a second spectral channel when in the second mosaic, the second spectral pattern being different than the first spectral pattern.
